(19) United States
(12) Patent Application Publication
(10) Pub. No.: US 2015/0256728 A1
(43) Pub. Date: Sep. 10, 2015

(54) IMAGING APPARATUS

(71) Applicant: SONY CORPORATION, TOKYO (JP)

(72) Inventor: MAYU KOSAKA, KANAGAWA (JP)

(21) Appl. No.: 14/633,504

(22) Filed: Feb. 27, 2015

(30) Foreign Application Priority Data
Mar. 7, 2014 (JP) 2014-045475

(51) Int. Cl. H04N 5/225; H04N 5/232

(52) U.S. Cl. CPC H04N 5/2254; H04N 5/23245

(57) ABSTRACT

There is provided an imaging apparatus including a first housing mounted with an imaging lens, a second housing mounted with a display, and a connecting portion that connects the first housing and the second housing. The connecting portion includes a first rotation mechanism that makes the second housing openable/closable with respect to the first housing by rotating the second housing around the opening/closing axis, and a second rotation mechanism that, in a case where the second housing is closed by the first rotation mechanism, when a surface of the first housing directly facing the second housing and parallel to the opening/closing axis is denoted as a first accommodation surface, makes the second housing rotatable around a vertical axis perpendicular to the first accommodation surface.

### CROSS REFERENCE TO RELATED APPLICATIONS

This application claims the benefit of Japanese Priority Patent Application JP 2014-045475 filed Mar. 7, 2014, the entire contents of which are incorporated herein by reference.

### BACKGROUND

The present technology relates to a technical field of an imaging apparatus including a first housing mounted with an imaging lens and a second housing mounted with a display and in which the second housing is enabled to rotate in a plurality of directions around axes.

In some of various imaging apparatuses such as video cameras and still cameras, a second housing mounted with a display is rotatably connected to a first housing mounted with an imaging lens (see, for example, JP2012-103465A (United States Patent Application Publication No. US20120113401)).

According to such an imaging apparatus, the direction in which the imaging lens points and the direction in which the display points can be made different and thus, various shooting styles, for example, high-angle shooting, low-angle shooting, self shooting (shooting in which both of the imaging lens and the display are pointed toward the cameraman) and so on can be supported.

In an imaging apparatus described in JP2012-103465A (United States Patent Application Publication No. US20120113401), the second housing (opening/closing portion) is enabled to rotate around an opening/closing axis formed in an up and down directions of the first housing (apparatus body) and a rotation axis orthogonal (perpendicular) to the opening/closing axis. With the second housing enabled to rotate in a plurality of directions around axes as described above, the relationship between the direction in which the imaging lens points and the direction in which the display points can be changed more diversely to be able to support more shooting styles.

### SUMMARY

However, the position of a hinge mechanism that rotatably connects the second housing is fixed in an imaging apparatus described in JP2012-103465A (United States Patent Application Publication No. US20120113401) and thus, if the second housing is rotated from a closed state (accommodated state) to an open state and then around the rotation axis (vertical axis), a portion of the second housing covers an accommodation surface (surface directly facing the second housing in the closed state) of the first housing.

Thus, if various operation buttons should be arranged on the accommodation surface of the first housing, it is necessary to take steps such as arranging operation buttons by avoiding a portion on the accommodation surface that may be covered with the second housing with rotation to prevent degradation in operability, leading to a lower degree of flexibility in arranging operation buttons.

According to embodiments of the present technology, therefore, it is desirable to prevent a lower degree of flexibility in arranging operation buttons in an imaging apparatus including a first housing mounted with an imaging lens and a second housing mounted with a display and in which the second housing is enabled to rotate in a plurality of directions around axes by overcoming the above problem.

First, according to an embodiment of the present disclosure, there is provided an imaging apparatus including a first housing mounted with an imaging lens, a second housing mounted with a display, and a connecting portion that connects the first housing and the second housing. The connecting portion includes a first rotation mechanism that makes the second housing openable/closable with respect to the first housing by rotating the second housing around the opening/closing axis, and a second rotation mechanism that, in a case where the second housing is closed by the first rotation mechanism, when a surface of the first housing directly facing the second housing and parallel to the opening/closing axis is denoted as a first accommodation surface, makes the second housing rotatable around a vertical axis perpendicular to the first accommodation surface.

Accordingly, when the second housing is rotated by the second rotation mechanism while the second housing is open, the second housing moves like making a circuit on the surface parallel to the first accommodation surface.

Second, according to an embodiment of the present disclosure, the imaging apparatus may further includes a control unit that sets a shooting mode in accordance with a rotation state of the second housing by the second rotation mechanism, preferably.

Accordingly, the shooting mode appropriate in accordance with the form of using the imaging apparatus is set.

Third, in the imaging apparatus according to an embodiment of the present disclosure, the control unit may set a self shooting mode when a rotation angle position of the second housing by the second rotation mechanism is a predetermined rotation angle position that makes the imaging lens and the opening/closing axis positioned at different locations when viewed from a side opposite to the first accommodation surface, and may set a normal shooting mode when the rotation angle position is a predetermined rotation angle position that makes the imaging lens and the opening/closing axis positioned at a same location when viewed from the side opposite to the first accommodation surface, preferably.

Accordingly, the self shooting mode and the normal shooting mode can be appropriately set separately each other in accordance with the form of using the imaging apparatus.

Fourth, in the imaging apparatus according to an embodiment of the present disclosure, the control unit may exercise control in a manner that a horizontally reversed image of a captured image obtained via the imaging lens in the self shooting mode is displayed on the display, preferably.

Accordingly, the display can be caused to function as a mirror in accordance with a case when the self shooting mode is set.

Fifth, in the imaging apparatus according to an embodiment of the present disclosure, the imaging lens may be mounted in a manner that an optical axis of an imaging optical system including the imaging lens is oriented in a direction parallel to the first accommodation surface, preferably. In accordance with opening of the second housing from a closed state, a protruding portion may be protruded from a bottom as a surface on an opposite side of the first accommodation surface of the first housing, preferably.

Accordingly, the angle of the imaging optical axis when the imaging apparatus is used in a stationary state is adjusted.

Sixth, in the imaging apparatus according to an embodiment of the present disclosure, at the bottom, the protruding portion may protrude from a neighborhood of an end on a side closer to a mounting position of the imaging lens, preferably.

Accordingly, the imaging optical axis is adjusted upward from the surface on which the imaging apparatus is placed.

Seventh, in the imaging apparatus according to an embodiment of the present disclosure, when the direction parallel to the optical axis is defined as a depth direction, a position from which the protruding portion protrudes may be a center portion in the direction orthogonal to the depth direction at the bottom, preferably.

Accordingly, the first housing can be prevented from tilting in the orthogonal direction (left and right directions) accompanying the protrusion of the protruding portion.

Eighth, in the imaging apparatus according to an embodiment of the present disclosure, an operation button may be formed on the first accommodation surface, preferably.

Accordingly, while holding the first housing like sandwiching between the side of the first accommodation surface and the bottom side, the cameraman can perform an operation by the thumb of the hand holding the first housing.

Ninth, in the imaging apparatus according to an embodiment of the present disclosure, the display may be mounted, among surfaces included in the second housing, on a second accommodation surface as the surface directly facing the first accommodation surface while the second housing is closed, preferably. Accordingly, the display does not appear while the second housing is closed.

Tenth, in the imaging apparatus according to an embodiment of the present disclosure, the second housing may have a substantially flat shape whose thickness direction is parallel to a thickness direction of the display, preferably. Accordingly, the thickness of the second housing can be suppressed.

Eleventh, in the imaging apparatus according to an embodiment of the present disclosure, preferably an outer edge shape and an outer edge size of the first housing when the first housing is viewed from a side opposite to the first accommodation surface, and an outer edge shape and an outer edge size of the second housing when the second housing is viewed from the side opposite to the second accommodation surface may be made substantially identical, respectively.

Accordingly, a step can be prevented from being generated on the outer surface of the imaging apparatus while the second housing is closed.

According to one or more of the embodiments of the present technology, a portion of the second housing is prevented from covering the first accommodation surface accompanying rotation around the vertical axis and it becomes unnecessary to take steps such as arranging operation buttons by avoiding a portion on the first accommodation surface that may be covered by the second housing accompanying the rotation and therefore, a lower degree of flexibility in arranging operation buttons can be prevented.

Incidentally, the effect described here should not necessarily be restricted and the effect may be any effect described in the present disclosure.

### BRIEF DESCRIPTION OF THE DRAWINGS

FIG. 1 is a front view of an imaging apparatus according to an embodiment;

FIG. 2 is a rear view of the imaging apparatus according to an embodiment;

FIG. 3 is a right side view of the imaging apparatus according to an embodiment;

FIG. 4 is a left side view of the imaging apparatus according to an embodiment;

FIG. 5 is a top view of the imaging apparatus according to an embodiment;

FIG. 6 is a bottom view of the imaging apparatus according to an embodiment;

FIG. 7 is an exploded perspective view illustrating a first rotation mechanism included in a connecting portion;

FIG. 8 is a top view of the imaging apparatus in which a second housing is opened;

FIG. 9 is a rear view of the imaging apparatus in which the second housing is opened;

FIGS. 10A, 10B, and 10C are explanatory views of a second rotation mechanism included in the connecting portion;

FIGS. 11A, 11B, and 11C are explanatory views of rotation modes of the second housing by the second rotation mechanism;

FIG. 12 is a perspective view showing a deformed state of the imaging apparatus corresponding to a normal transverse shooting mode;

FIG. 13 is a perspective view showing a deformed state of the imaging apparatus corresponding to a normal longitudinal shooting mode;

FIG. 14 is a perspective view showing a deformed state of the imaging apparatus corresponding to a self shooting mode;

FIGS. 15A, 15B, and 15C are explanatory views of a shooting angle corresponding to the normal transverse shooting mode;

FIGS. 16A, 16B, and 16C are explanatory views of the shooting angle corresponding to the normal longitudinal shooting mode;

FIG. 17 is a block diagram showing a circuit configuration inside the imaging apparatus;

FIG. 18 is a left side view of an imaging apparatus 1 in a stationary shooting state placed on a placement object such as a table while a protruding portion is protruded;

FIG. 19 is a flow chart illustrating processing in accordance with a shooting mode; and

FIG. 20 is a flow chart illustrating processing in accordance with a shooting state of the imaging apparatus.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment will be described in the order shown below:

### <1. Appearance/Structure of Imaging Apparatus>

### <2. Shooting Mode and Shooting State>

### <3. Internal Configuration of Imaging Apparatus>

<4. Processing in Accordance with Shooting Mode/Shooting State>

### <5. Summary of Embodiments>

### <6. Modification>

### <7. Present Technology>

<1. Appearance/Structure of Imaging Apparatus>

Hereinafter, the imaging apparatus 1 as an embodiment according to the present technology will be described with reference to the appended drawings.

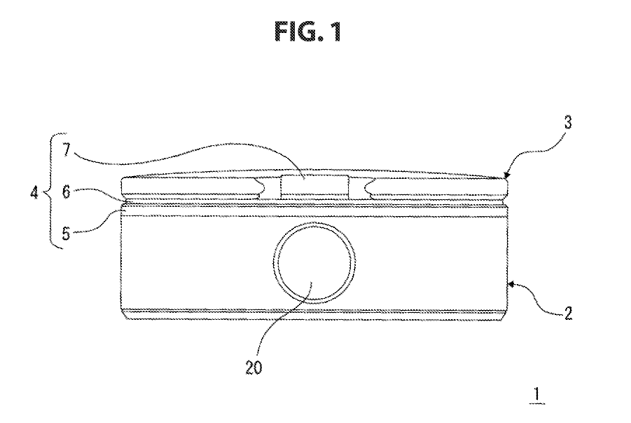

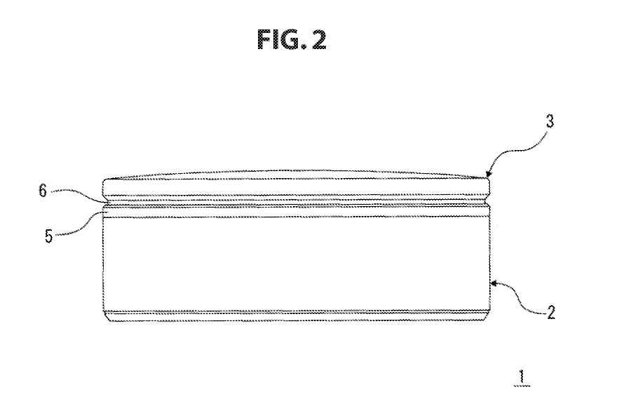

FIGS. 1 to 6 are six drawings of the imaging apparatus 1 and a front view, a rear view, a right side view, a left side view, a top view and a bottom view of the imaging apparatus 1 respectively. In the imaging apparatus 1, as will be described later, a second housing 3 is openable/closable with respect to a first housing 2 by the second housing 3 being made rotatable around an opening/closing axis ax1 in a connecting portion 4, but the six drawings in FIGS. 1 to 6 show the imaging apparatus 1 in which the second housing 3 is closed.

The imaging apparatus 1 includes the first housing 2 mounted with an imaging lens 20, the second housing 3 mounted with a display 10 described later, and the connecting portion 4 connecting the first housing 2 and the second housing 3.

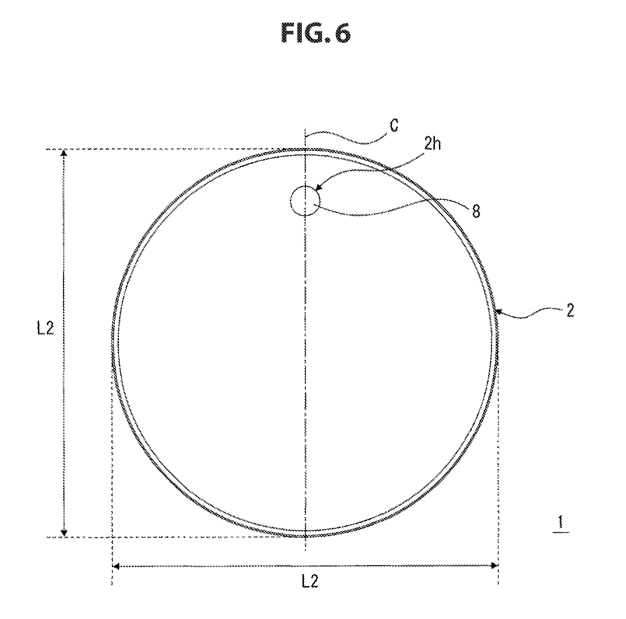

The first housing 2 has a substantially cylindrical outside shape and a top face and a bottom face positioned on the opposite side of the top face each have a substantially circular shape. The imaging lens 20 is mounted in a predetermined position on the side face of the first housing 2. A protruding portion accommodation port 2h accommodating a protruding portion 8 is provided on the bottom face of the first housing 2 (see FIG. 6). In the present example, the protruding portion 8 is rod-like (pin type). The protruding portion 8 will be described later.

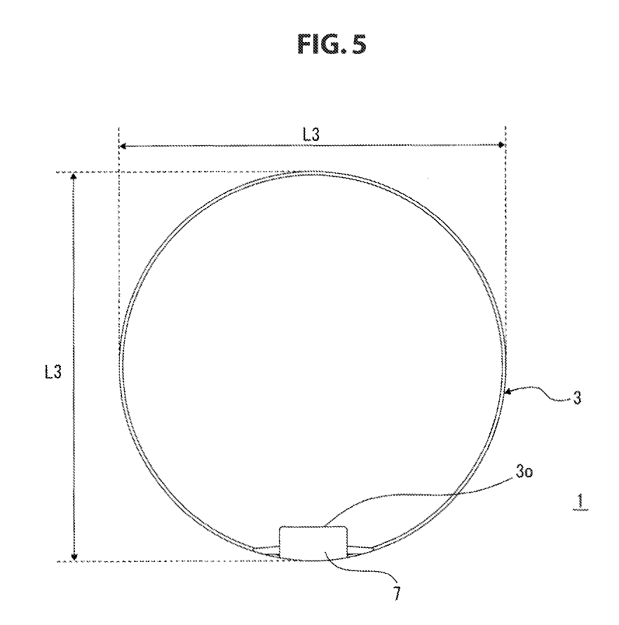

The second housing 3 is based on a substantial disk shape and a portion of an outer circumferential portion is hollowed in a rectangular shape to be convex on an inner circumferential side. The hollowed portion is denoted by a “recess 3o” below (see FIG. 5). The recess 3o is formed to secure a space in which a connecting member 7 described below of the connecting portion 4 is arranged.

The connecting portion 4 includes a first annular member 5, a second annular member 6, and the connecting member 7. The first annular member 5 and the second annular member 6 each have a substantially annular outside shape and are arranged between the first housing 2 and the second housing 3. The outside diameter of the first annular member 5 and the second annular member 6 substantially matches that of the first housing 2 and the second housing 3.

Details of the first annular member 5 and the second annular member 6 will be described later.

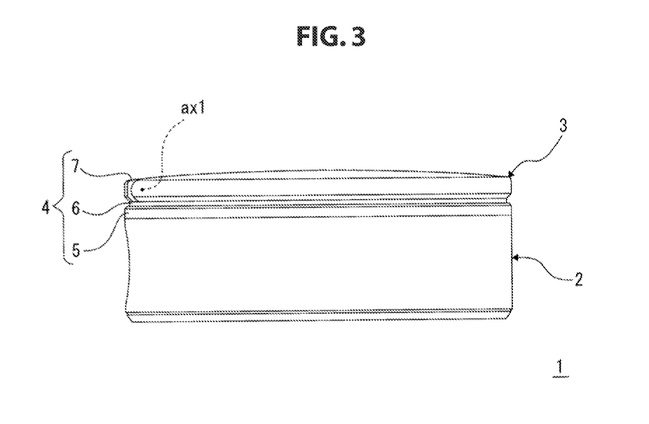

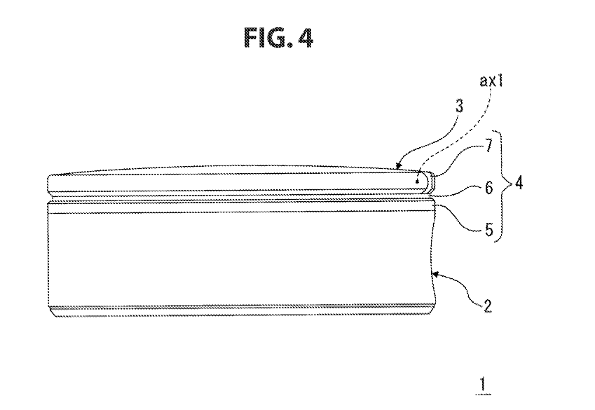

The connecting member 7 has a substantially rectangular parallelopiped outside shape and is fixed to one end on the top face of the second annular member 6 (see FIGS. 3 and 4). The connecting member 7 is just accommodated inside the aforementioned recess 3o while the second housing 3 is closed (see FIG. 5).

In the present embodiment, as is evident by referring to FIG. 6, the outer edge shape of the first housing 2 when viewed in the bottom view is substantially circular and, as is evident by referring to FIG. 5, the outer edge shape of the second housing 3 when viewed in the top view is also substantially circular (in the present example, the shape is circular when the connecting member 7 is just accommodated inside the recess 3o). That is, the outer edge shape of the first housing 2 when viewed in the bottom view and the outer edge shape of the second housing 3 when viewed in the top view are set to be substantially the same.

Further in the present embodiment, the outer edge size of the first housing 2 when viewed in the bottom view in FIG. 6 and the outer edge size of the second housing 3 when viewed in the top view in FIG. 5 are set to be substantially the same. More specifically, in the present example, the diameter of the first housing 2 shown in FIG. 6 as “L2” and the diameter of the second housing 3 shown in FIG. 5 as “L3” are set to be substantially the same and the outer edge size of the first housing 2 when viewed in the bottom view and the outer edge size of the second housing 3 when viewed in the top view are substantially the same.

“The outer edge of the first housing 2 when viewed in the bottom view” described above can also be expressed as the outer edge of the first housing 2 when viewed from the side opposite to a first accommodation surface 2s described later in the first housing 2 and “the outer edge of the second housing 3 when viewed in the top view” can also be expressed as the outer edge of the second housing 3 when viewed from the side opposite to a second accommodation surface 3s described later in the second housing 3.

As is evident by referring to FIGS. 1 to 6, the imaging apparatus 1 has a substantially cylindrical outside shape when the second housing 3 is closed.

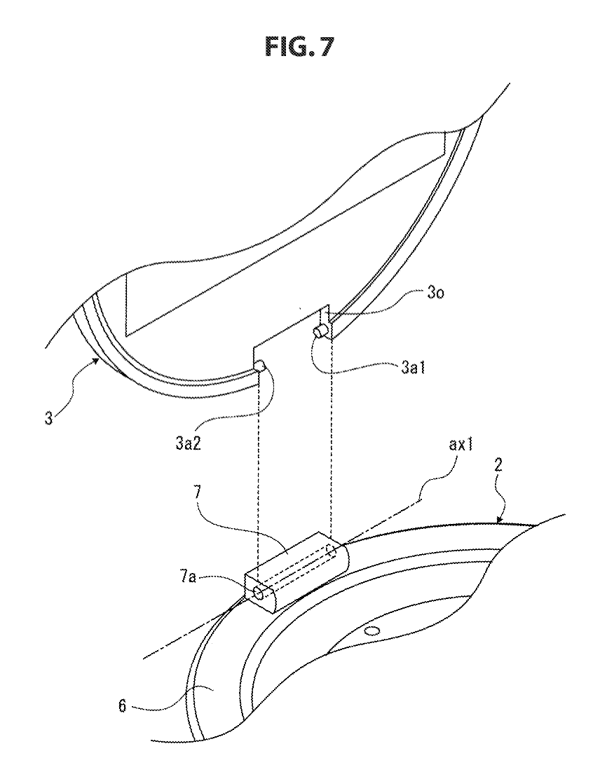

FIG. 7 is an exploded perspective view illustrating a first rotation mechanism included in the connecting portion 4 and extracts the neighborhood of a connecting portion of the connecting member 7 and the second housing 3 in the imaging apparatus 1.

The second housing 3 has a protruding portion 3a1 formed on one of two surfaces forming the aforementioned recess 3o and opposed to each other and a protruding portion 3a2 formed on the other surface. These protruding portions 3a1, 3a2 are formed in a substantially cylindrical shape.

A through hole 7a passing through the connecting member 7 in a substantially cylindrical shape is formed in the connecting member 7 in the connecting portion 4.

The connecting member 7 is fixed to the second annular member 6 such that the through hole 7a points in the direction defined below. That is, the through hole points in a direction parallel to the first accommodation surface 2s described later and perpendicular to the radial direction of the first accommodation surface 2s.

The protruding portion 3a1 formed in the second housing 3 is inserted through one opening of the through hole 7a and the protruding portion 3a2 is inserted through the other opening of the through hole 7a. Accordingly, the second housing 3 is made rotatable around the opening/closing axis ax1 as the center axis of the through hole 7a. That is, the second housing 3 is openable/closable with respect to the first housing 2.

The state in which the second housing 3 is closed as shown in FIGS. 1 to 6 can also be expressed as a state in which the second housing 3 is accommodated on the side of the first housing 2. Therefore, the state in which the second housing 3 is closed will also be denoted as a state in which the second housing 3 is “accommodated”.

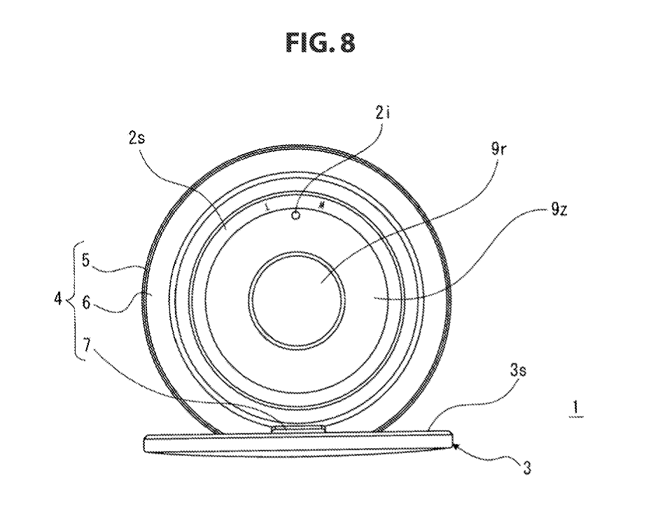

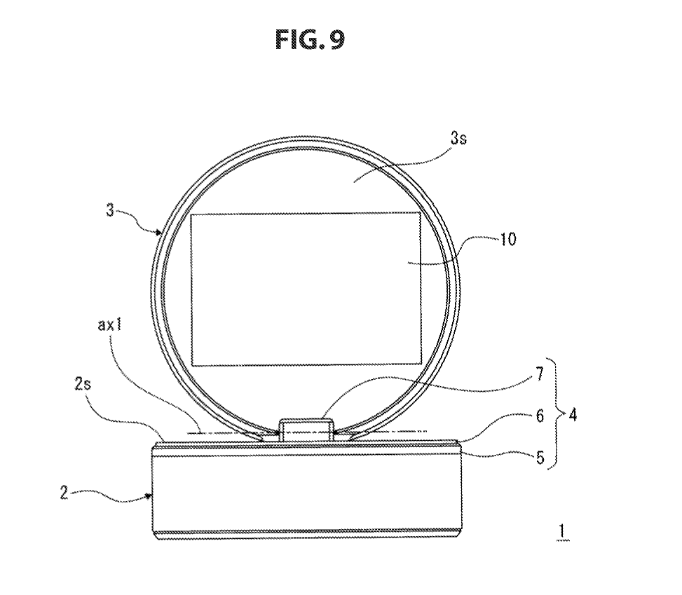

FIGS. 8 and 9 are a top view and a rear view of the imaging apparatus 1 in which the second housing 3 is opened.

In the top view shown in FIG. 8, the top face of the first housing 2 becomes a surface that directly faces the second housing 3 when the second housing 3 is closed as shown in FIGS. 1 to 6. The surface of the first housing 2 directly facing the second housing 3 when the second housing 3 is closed will be denoted as the “first accommodation surface 2s” below.

As is evident by referring to FIG. 9, the first accommodation surface 2s is a surface parallel to the opening/closing axis ax1.

The first accommodation surface 2s has a REC button 9r and a zoom button 9z as operation buttons for the cameraman (user) to do operation input into the imaging apparatus 1 formed thereon (see FIG. 8).

The REC button 9r is set in the present example as an operation button to instruct the start/stop of recording of at least moving images. The zoom button 9z is set as an operation button to perform at least a zoom operation (angle of view adjustment operation).

The REC button 9r is a substantially circular button and is arranged such that the center of first accommodation surface of substantially matches the center of the first accommodation surface 2s. The zoom button 9z is a substantially annular button whose inside diameter is larger than the outside diameter of the REC button 9r and whose outside diameter is smaller than the inside diameter of the second annular member 6 and is arranged such that the center of the REC button 9r substantially matches the center of the first accommodation surface 2s.

The zoom button 9z in the present example has an operation region divided by a parting line between the denoted symbols “T” and “W” in FIG. 8 and the cameraman can give zoom instructions to the tele terminal side by pressing an operation region on the “T” side of the zoom button 9z and zoom instructions to the wide terminal side by pressing an operation region on the “W” side.

Each operation button such as the REC button 9r and the zoom button 9z is not limited to a pressing button and operation buttons of other modes such as a touch sensor mode can also be adopted. Particularly regarding the zoom operation, various modes such as the touch sensor mode and sliding mode can be considered. If, for example, the touch sensor mode is adopted for a ring-shaped operation button like the zoom button 9z, an operation along one rotation direction of the counterclockwise/clockwise rotation of the ring-shaped operation button can be allocated as a zoom instruction operation to the tele terminal side and an operation along the other rotation direction can be allocated as a zoom instruction operation to the wide terminal side. Alternatively, if, for example, the sliding mode is adopted for a ring-shaped operation button, an operation to rotate the ring-shaped operation button in one rotation direction of the counterclockwise/clockwise rotation can be allocated as a zoom instruction operation to the tele terminal side and an operation to rotate the ring-shaped operation button in the other rotation direction can be allocated as a zoom instruction operation to the wide terminal side.

In the present embodiment, the zoom button 9z has a luminous portion as an indicator 2i formed in a predetermined position. The indicator 2i has a function to notify the cameraman whether the imaging apparatus 1 is currently recording through at least a lighting state thereof.

In the present example, the indicator 2i is formed in a position on the opposite side of the side on which the imaging lens 20 is mounted when the center of the first accommodation surface 2s is viewed as a reference. In FIG. 8, the mounting position of the imaging lens 20 in the first housing 2 is on the side on which the connecting member 7 is positioned.

In FIG. 9, the display 10 is mounted on the second housing 3. More specifically, the display 10 is mounted on, among surfaces included in the second housing 3, the surface directly facing the first housing 2 when the second housing 3 is closed.

Hereinafter, among surfaces included in the second housing 3, the surface of the second housing 3 directly facing the first housing 2 when the second housing 3 is closed will be denoted as the “second accommodation surface 3s”.

In the present embodiment, the display 10 has a substantially rectangular shape and is mounted on the second accommodation surface 3s in a direction in which the long side of the display 10 is parallel to the aforementioned opening/closing axis ax1.

A touch panel is formed on the display 10 and the cameraman is enabled to do input of various operations into the imaging apparatus 1 also through a touch operation of the touch panel.

As is understood from the description heretofore, the second housing 3 has a substantially flat shape whose thickness direction is parallel to the thickness direction of the display 10.

The imaging apparatus 1 according to the present embodiment is configured such that the power is turned on/off by the second housing 3 being opened/closed. More specifically, the imaging apparatus 1 is turned on by the second housing 3 being opened by a predetermined angle or more from the accommodated state of the second housing 3 around the opening/closing axis ax1 and the imaging apparatus 1 is turned off by the second housing 3 being closed to the accommodated state.

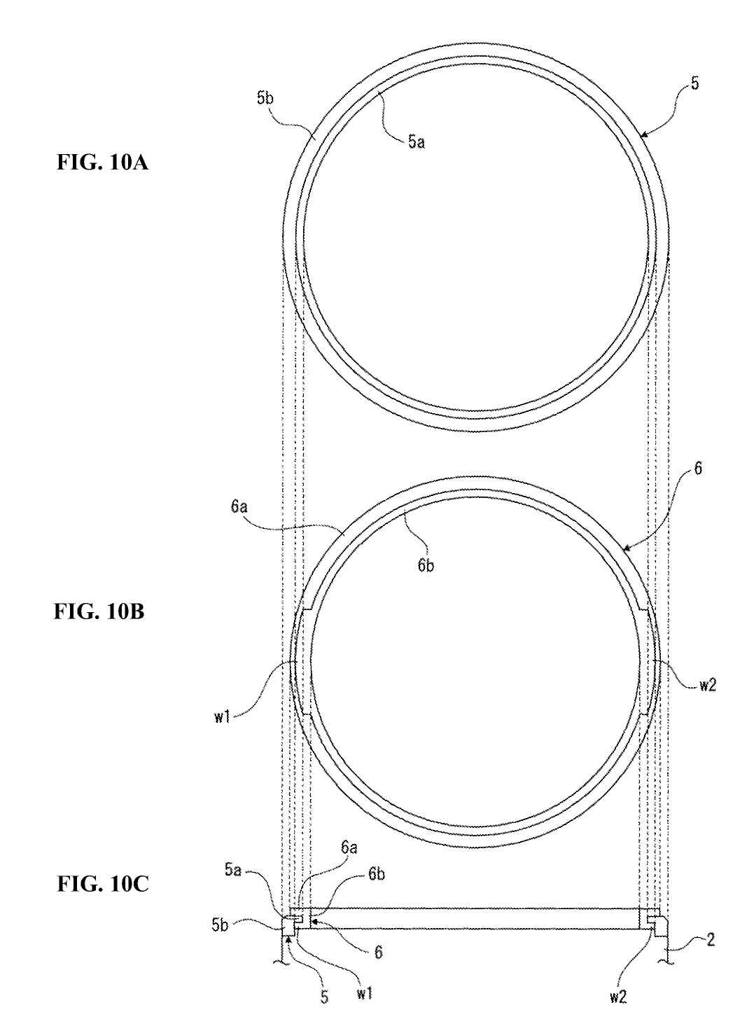

FIGS. 10A, 10B, and 10C are explanatory views of a second rotation mechanism included in the connecting portion 4. FIG. 10A is a bottom view of the first annular member 5, FIG. 10B is a bottom view of the second annular member 6, and FIG. 10C is a sectional view extracting and showing the neighborhood of a fitting portion of the first annular member 5 and the second annular member 6 in the imaging apparatus 1.

The first annular member 5 is an annular member whose sectional shape is a substantial L shape. The first annular member 5 includes a first height 5a protruding in a direction parallel to the radial direction of the first annular member 5 and a second height 5b protruding in a direction orthogonal to the radial direction.

The first height 5a is formed to be convex to the inner circumferential side of the first annular member 5 relative to the second height 5b and thus, in the first annular member 5, the inside diameter of the first height 5a is made smaller than that of the second height 5b.

Hereinafter, among surfaces included in the first height 5a, the surface pointing to the opposite side of the protruding direction of the second height 5b will be denoted as a “front surface”. In addition, the surface pointing to the opposite side of the “front surface” in the first height 5a will be denoted as a “back surface”. Similarly, the surface pointing to the opposite side of the front surface of the first height 5a in the second height 5b (tip surface in the protruding direction of the second height 5b) will be denoted as a “back surface”.

The second annular member 6 includes a blade portion w1 and a blade portion w2 and is an annular member whose sectional shape in portions where the blade portions w1, w2 are formed is a substantial U shape and whose sectional shape in other portions is a substantial L shape. The second annular member 6 includes a first height 6a protruding in a direction parallel to the radial direction of the second annular member 6 and a second height 6b protruding in a direction orthogonal to the radial direction. The blade portion w1 and the blade portion w2 are each formed as an extended portion of the width of the second height 6b (length in a direction parallel to the radial direction of the second annular member 6) in an outer circumferential direction.

The first height 6a is formed to be convex to the outer circumferential side of the second annular member 6 relative to the second height 6b and thus, in the second annular member 6, the outside diameter of the first height 6a is made larger than that of the second height 6b.

Also in the second annular member 6, among surfaces included in the first height 6a, the surface pointing to the opposite side of the protruding direction of the second height 6b will be denoted as a “front surface” and the surface pointing to the opposite side of the “front surface” in the first height 6a will be denoted as a “back surface”. Similarly, the surface pointing to the opposite side of the front surface of the first height 6a in the second height 6b (tip surface in the protruding direction of the second height 6b) will be denoted as a “back surface”.

In each of the blade portion w1 and the blade portion w2, the surface pointing to the same direction as the front surface of the first height 6a will be denoted as a “front surface”.

In the connecting portion 4, as shown in FIG. 10C, tip portions of the first height 5a in the first annular member 5 are each fitted to the second annular member 6 by being sandwiched between the first height 6a and blade portion w1 and between the first height 6a and the blade portion w2 in the second annular member 6. The fitting is performed such that the back surface of the first height 6a and the front surface of the first height 5a are in contact and the back surface of the first height 5a and the front surface of the blade portions w1, w2 are in contact.

The first annular member 5 fitted to the second annular member 6 as described above is fixed to the first housing 2 on the back surface side of the second height 5b.

At this point, the first annular member 5 is fixed to the first housing 2 such that the aforementioned first accommodation surface 2s and the front surface of the first height 5a of the first annular member 5 are parallel. Also in the present example, while the first annular member 5 to which the second annular member 6 is fitted as described above is fixed to the first housing 2, the center axis of the first annular member 5 and the second annular member 6 in an annular shape substantially matches the center axis of the first housing 2 in a substantially cylindrical shape.

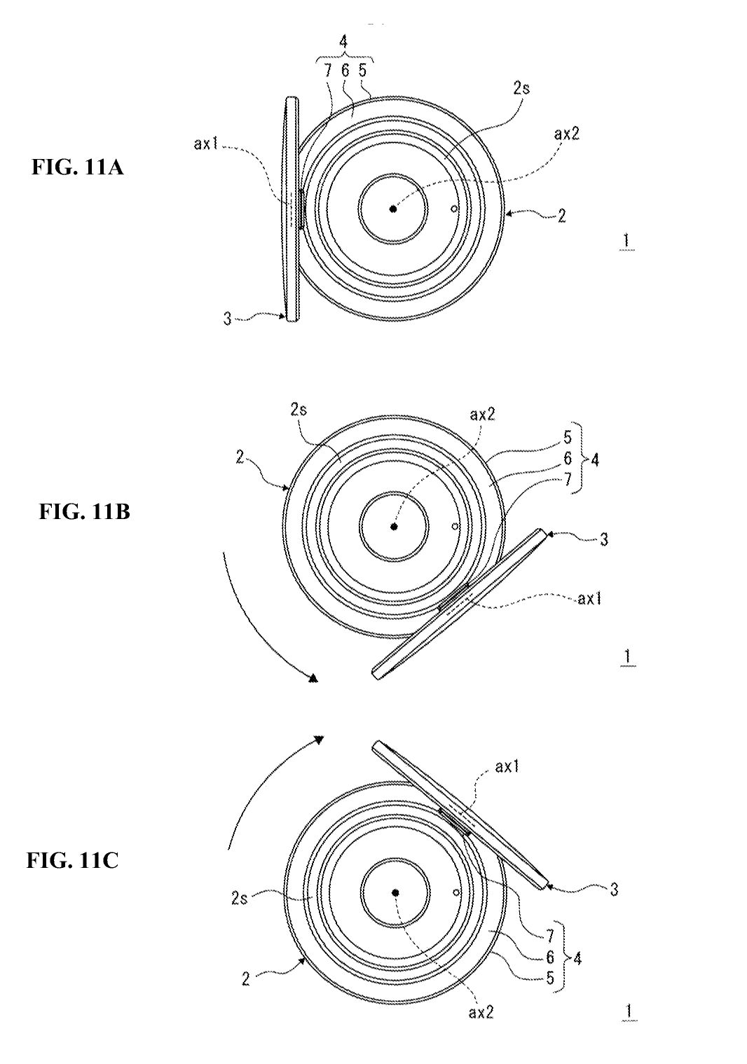

The second housing 3 is made rotatable around a vertical axis ax2 shown in top views of FIGS. 11A to 11C, that is, around an axis perpendicular to the first accommodation surface 2s by the second rotation mechanism structured as described above. In other words, the second housing 3 is made rotatable around the vertical axis ax2 perpendicular to the first accommodation surface 2s and positioned on the inner side from the outer circumference of the first housing 2 (outer circumference of the first accommodation surface 2s). More specifically, in the present example in which, as described above, the center axis of the first annular member 5 and the second annular member 6 and the center axis of the first housing 2 substantially match, the second housing 3 is made rotatable around the vertical axis ax2 substantially matching the center axis of the first housing 2.

Because, as described above, the first accommodation surface 2s is a surface parallel to the opening/closing axis ax1, the vertical axis ax2 is an axis that is, as described above, perpendicular to the first accommodation surface 2s and at the same time, perpendicular also to the opening/closing axis ax1.

According to the second rotation mechanism described above, with the second annular member 6 not fixed to the first housing 2 being rotated around the vertical axis ax2, the second housing 3 connected via the connecting member 7 fixed to the second annular member 6 rotates around the vertical axis ax2 with respect to the first housing 2.

As is evident by referring to FIGS. 11A to 11C, also the opening/closing axis ax1 rotates around the vertical axis ax2 accompanying the rotation of the second housing 3 around the vertical axis ax2.

Because, as described above, the connecting member 7 is fixed to the second annular member 6, the opening/closing axis ax1 is positioned on an outer circumference of the first housing 2. In other words, the opening/closing axis ax1 is positioned in an outer edge portion of the first accommodation surface 2s of the first housing 2.

According to the aforementioned second rotation mechanism, as is also understood from above, the opening/closing axis ax1 is rotated along the outer edge of the first accommodation surface 2s accompanying the rotation of the second housing 3 around the vertical axis ax2.

<2. Shooting Mode and Shooting State>

A plurality of shooting modes is provided for the imaging apparatus 1 according to the present embodiment configured as described above. In the present embodiment, the shooting mode is roughly divided into a normal shooting mode and a self shooting mode and further, two modes, a normal transverse shooting mode and a normal longitudinal shooting mode, are provided for the normal shooting mode.

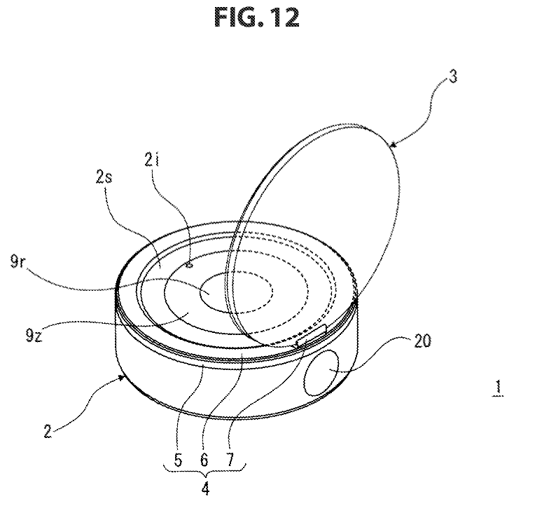

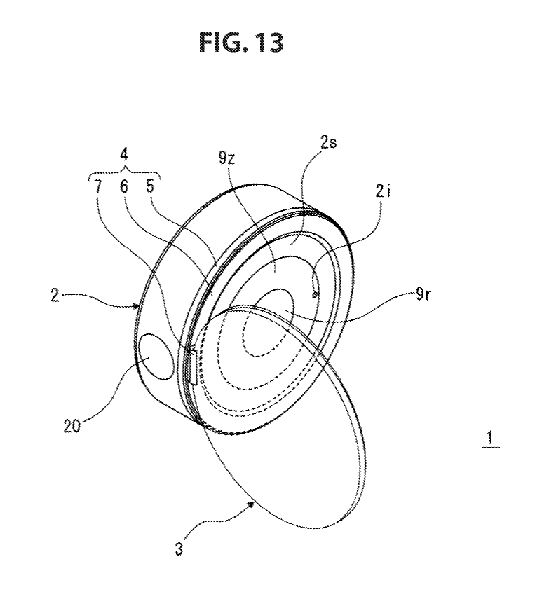

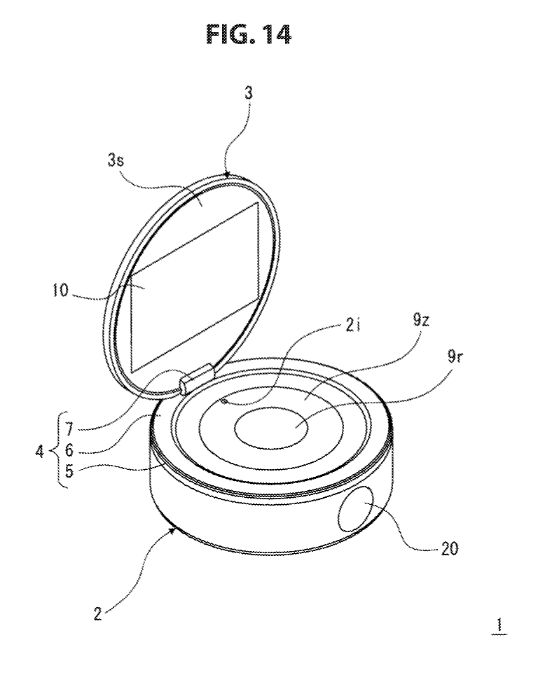

FIG. 12 shows the normal transverse shooting mode, FIG. 13 shows the normal longitudinal shooting mode, and FIG. 14 shows a deformed state of the imaging apparatus 1 corresponding to the self shooting mode. The deformed state of the imaging apparatus 1 here is a deformed state of the imaging apparatus 1 accompanying the rotation of the second housing 3.

The normal transverse shooting mode and the normal longitudinal shooting mode shown in FIGS. 12 and 13 respectively are both shooting modes corresponding to a case when shot by pointing the imaging lens 20 to the same side as a line-of-sight direction of the cameraman and pointing the display 10 to the side of the cameraman as the normal transverse shooting mode.

The self shooting mode shown in FIG. 14 is, on the other hand, is a shooting mode corresponding to a case when shot by pointing both of the imaging lens 20 and the display 10 to the side of the cameraman.

Here, a deformed state of the imaging apparatus 1 corresponding to the normal shooting mode can be defined as a state in which the second housing 3 is rotated around the opening/closing axis ax1 such that the second housing 3 is opened from the accommodated state by a predetermined angle or more and also the second housing 3 is rotated around the vertical axis ax2 such that the connecting member 7 in the connecting portion 4 is positioned on the same side as the direction in which the imaging lens 20 points.

More specifically, a deformed state corresponding to the normal shooting mode in the present example can be defined as a state in which regarding the direction around the opening/closing axis ax1, the second housing 3 is opened by a rotation angle that turns on the imaging apparatus 1 or more and, regarding the direction around the vertical axis ax2, if, as shown in FIGS. 1 to 6, the angle when the connecting member 7 is positioned immediately above the imaging lens 20 is set as 0 degrees (360 degrees), the rotation angle of the second housing 3 is in the range of 270 degrees or more and less than 90 degrees centering at 0 degrees.

In this case, it is assumed that when viewed in the top views shown in FIGS. 11A to 11C (that is, when viewed from the side opposite to the first accommodation surface 2s), the rotation angle around the vertical axis ax2 increases in the counterclockwise direction.

Hereinafter, the rotation angle around the opening/closing axis ax1 will be denoted as a “rotation angle θ1” and the rotation angle around the vertical axis ax2 will be denoted as a “rotation angle θ2”.

In the normal transverse shooting mode shown in FIG. 12, with the range of the rotation angle θ1 being allowed in a relatively wide range as shown above, the difference of angles of the direction in which the imaging lens 20 points (imaging direction) and the direction in which the display 10 points can widely be allowed so that the range of shooting angle that can be supported can be increased.

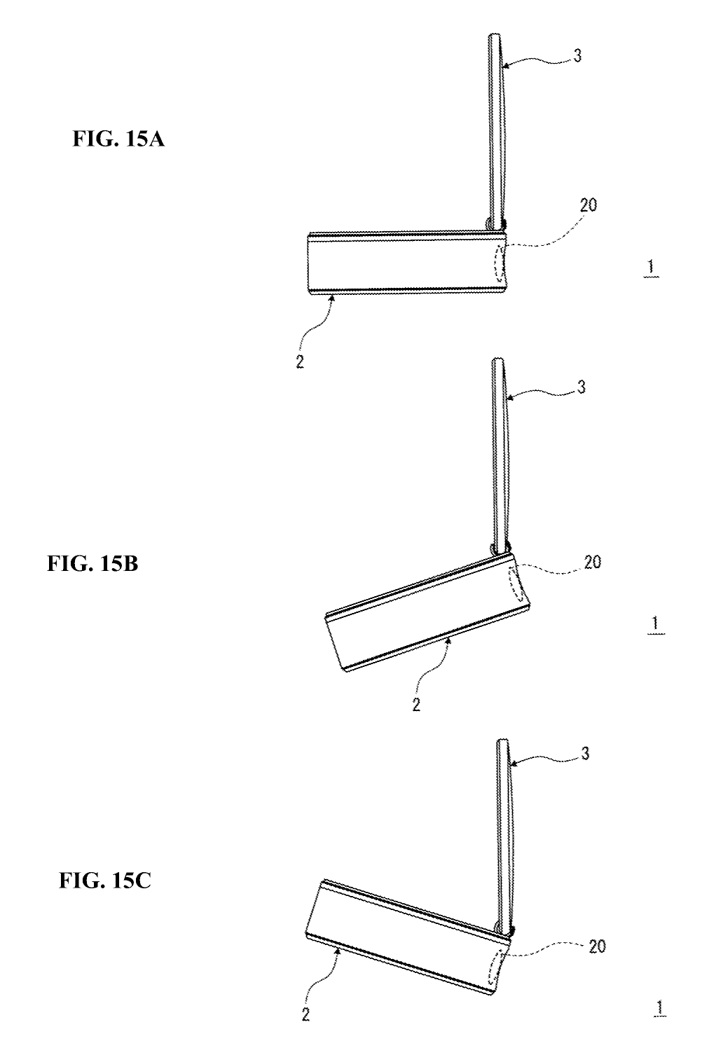

That is, in the normal transverse shooting mode, relative to a horizontal angle shooting state in which the rotation angle θ1=substantial 90 degrees as shown in FIG. 15A, a shooting state in which the rotation angle θ1 is increased as shown in FIG. 15B is a high-angle shooting state and a shooting state in which the rotation angle θ1 is decreased as shown in FIG. 15C is a low-angle shooting state and therefore, with the range of the rotation angle θ1 being allowed relatively widely, the range of shooting angle that can be supported can be increased.

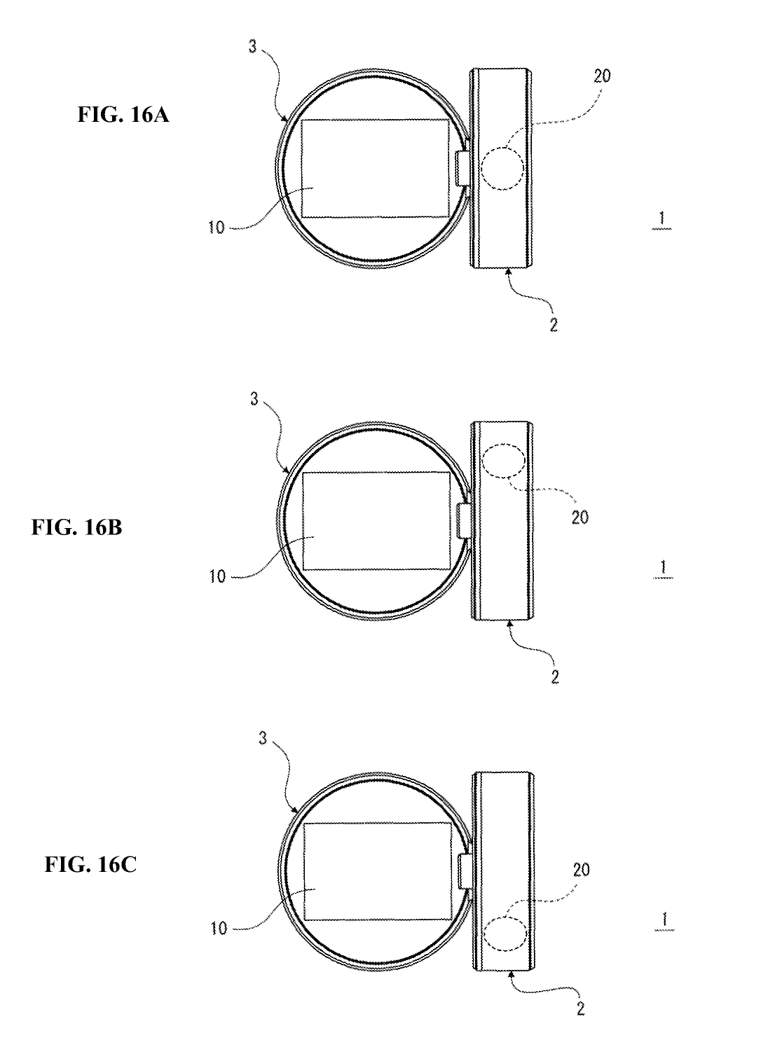

In the normal longitudinal shooting mode, on the other hand, relative to the horizontal angle shooting state in which the rotation angle θ2=substantial 0 degree shown in FIG. 16A, a shooting state in which the rotation angle θ2 is increased as shown in FIG. 16B is a high-angle shooting state and a shooting state in which the rotation angle θ2 is decreased as shown in FIG. 16C is a low-angle shooting state.

In the normal longitudinal shooting mode, therefore, with the range of the rotation angle θ2 being allowed in a relatively wide range as shown above, the difference of angles of the direction in which the imaging lens 20 points and the direction in which the display 10 points can widely be allowed so that the range of shooting angle that can be supported can be increased.

Here, a landscape shooting state assumed by the normal transverse shooting mode can be expressed as a state of shooting with the first accommodation surface 2s of the first housing 2 upward. Also, a portrait shooting state assumed by the normal longitudinal shooting mode can be expressed as a state of shooting with the first accommodation surface 2s of the first housing 2 to the left or to the right.

As will be described later, the normal transverse shooting mode and the normal longitudinal shooting mode are distinguished by determining whether the posture of the imaging apparatus 1 is landscape orientation or portrait orientation.

A deformed state corresponding to the self shooting mode shown in FIG. 14 can be defined as a state in which regarding the direction around the opening/closing axis ax1, the second housing 3 is opened by a rotation angle θ1 that turns on the imaging apparatus 1 or more and, regarding the direction around the vertical axis ax2, if the rotation angle θ2 when the connecting member 7 is positioned immediately above the imaging lens 20 is set as 0 degrees (360 degrees), the rotation angle θ2 of the second housing 3 is in the range of 90 degrees or more and less than 270 degrees centering at 180 degrees.

Whether or not the self shooting mode can be distinguished based on only the deformed state of the imaging apparatus 1.

Though not illustrated, with the allowed range of the rotation angle θ1 being set to be relatively wide also in the self shooting mode as described above, the range of shooting angle that can be supported can be increased like the normal transverse shooting mode.

While the self shooting mode is assumed to be a shooting mode corresponding to the landscape shooting only in the present embodiment, the self shooting made may also be allowed to be a mode corresponding to the longitudinal shooting and in such a case, with the allowed range of the rotation angle θ2 being set to be relatively wide as described above, the range of shooting angle that can be supported can be increased like the longitudinal shooting mode.

When one of the above three shooting modes is set, the imaging apparatus 1 according to the present embodiment is enabled to shoot both of moving images and still images. In this case, switching of shooting between moving images and still images is enabled by, for example, a touch operation on an operation button displayed on the display 10.

Incidentally, the normal longitudinal shooting mode may be set as a shooting mode capable of shooting only still images.

In the present embodiment, a hand-held shooting state and a stationary shooting state are defined as shooting state of the imaging apparatus 1.

The hand-held shooting state means a state in which the imaging apparatus 1 is hand-held by the cameraman for shooting and the stationary shooting state means a state in which the imaging apparatus 1 is placed on a placement object such as a table for shooting.

<3. Internal Configuration of Imaging Apparatus>

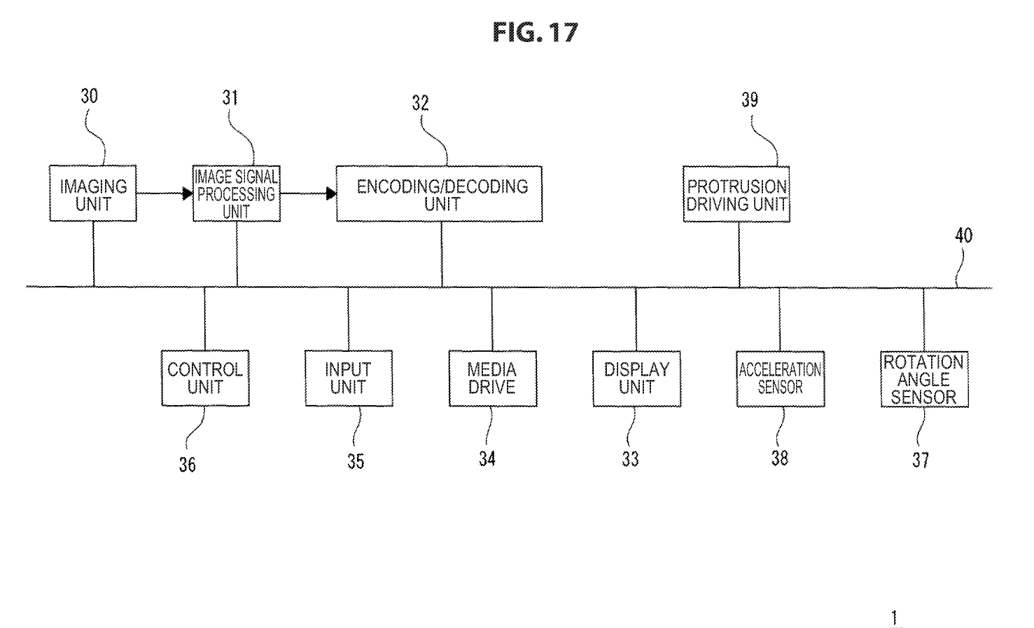

FIG. 17 is a block diagram showing a circuit configuration inside the imaging apparatus 1.

An imaging unit 30, an image signal processing unit 31, an encoding/decoding unit 32, a display unit 33, a media drive 34, an input unit 35, a control unit 36, a rotation angle sensor 37, an acceleration sensor 38, a protrusion driving unit 39, and a bus 40 are provided inside the imaging apparatus 1. Each unit excluding the bus 40 is mutually connected via the bus 40 to exchange various kinds of data and control signals.

The imaging unit 30 includes a lens unit having the imaging lens 20, an imaging device, for example, a charge coupled device (CCD) image sensor or a complementary metal oxide semiconductor (CMOS) image sensor that converts subject light obtained via the lens unit into an electric signal (imaging signal) through photoelectric conversion, a sample hold/automatic gain control (AGC) circuit that makes gain adjustments of a signal obtained (read) by the imaging device or shapes the waveform thereof, and a video A/D converter and obtains captured image data as digital data.

The imaging unit 30 has a function to adjust the focal length (focus), the angle of view (zoom), the shutter speed, the diaphragm and the like based on the control of the control unit 36.

The image signal processing unit 31 performs various kinds of image signal processing on captured image data obtained by the imaging unit 30. For example, gradation correction processing, shading correction processing, high-frequency correction (contour correction) processing, camera shake compensation processing and the like are performed.

The encoding/decoding unit 32 performs compression processing of captured image data on which image signal processing has been performed by the image signal processing unit 31 and decompression processing of captured image data on which the compression processing has been performed. As the compression/decompression mode, compression/decompression processing based on a predetermined still image format, for example, the joint photographic experts group (JPEG) format is performed on still images and compression/decompression processing based on a predetermined moving image format, for example, the moving picture experts group (MPEG) format or advanced video codec high definition (AVCHD) format is performed on moving images.

The display unit 33 has the display 10 and displays various kinds of information based on the control of the control unit 36. The media drive 34 includes a recording and playback circuit/mechanism for a semiconductor memory such as a flash memory or a recording medium such as a magnetic disk, optical disk, magneto-optical disk and the like. The media drive 34 records various kinds of data such as compressed captured image data in moving image format or still image format obtained by the encoding/decoding unit 32 based on the control of the control unit 36 on a recording medium or reads various kinds of data such as compressed captured image data recorded on a recording medium.

The input unit 35 includes operation buttons (not illustrated) for the cameraman to do input of various operations, a touch panel and the like into the imaging apparatus 1 and detects a user's input operation to convey the information (operation input information) in accordance with the input operation to the control unit 36. In the present example, the input unit 35 includes the REC button 9r, the zoom button 9z described above and the display 10.

The rotation angle sensor 37 is formed of a rotary encoder or the like and detects the rotation angle θ1 of the second housing 3 by the first rotation mechanism and the rotation angle θ2 of the second housing 3 by the second rotation mechanism described above.

The rotation angle sensor 37 in the present example detects the rotation angles θ1, θ2 by assuming that the rotation angle θ1 is 0 degrees when the second housing 3 is accommodated and the rotation angles θ2 is 0 degrees (360 degrees) when the connecting member 7 is positioned immediately above the imaging lens 20. In the present example, the rotation angle sensor 37 is configured such that regarding the rotation angle θ1, the more the second housing 3 is opened, the larger the value of the detected rotation angle θ1 is and regarding the rotation angle θ2, an increasing value of the rotation angle θ2 is detected with counterclockwise rotation of the second housing 3 when viewed from the side opposite to the first accommodation surface 2s.

The rotation angle sensor 37 has a function to detect a deformed state of the imaging apparatus 1 accompanying the rotation of the second housing 3, but the function can also be realized without the rotation angle sensor 37. If, for example, it is enough like in the present example to distinguish between the normal shooting mode when the rotation angle θ2 is “270 degrees≦θ2<90 degrees” and the self shooting mode when the rotation angle is “90 degrees≦θ2<270 degrees”, a deformed state of the imaging apparatus 1 can be detected based on ON/OFF of a switch that is turned on when the second housing 3 is rotated such that the rotation angle θ2 is in a range of one of “270 degrees≦θ2<90 degrees” and “90 degrees≦θ2<270 degrees” and turned off when the second housing 3 is rotated such that the rotation angle θ2 is in other ranges. More specifically, for example, a conductor is formed only in one of the ranges of “270 degrees≦θ2<90 degrees” and “90 degrees≦θ2<270 degrees” and the switch is configured such that the switch is turned on only when a contact rotating together with the second housing 3 comes into contact with the conductor. In this case, the formation point of the contact is the position immediately below the connecting member 7 in view of the fact that the angle when the connecting member 7 is positioned immediately above the imaging lens 20 is 0 degrees (360 degrees).

The acceleration sensor 38 detects the acceleration of gravity. In the present example, for example, a three-axis sensor is used as the acceleration sensor 38. It is known that the direction in which the gravity acts can be detected from a DC component of an acceleration detection signal by the acceleration sensor 38 and the vibration can be detected from an AC component of the acceleration detection signal.

The protrusion driving unit 39 is a comprehensive representation of a mechanism and an actuator to drive the protruding portion 8. The protruding portion 8 is maintained deformable between a state of protruding from the bottom of the first housing 2 and a state of not protruding from the bottom by the protrusion driving unit 39.

The actuator of the protrusion driving unit 39 generates a driving force to drive the protruding portion 8 based on the control of the control unit 36.

The control unit 36 is formed of a microcomputer including a central processing unit (CPU), a read only memory (ROM), a random access memory (RAM) and the like and controls the whole imaging apparatus 1 by performing processing according to a program stored in, for example, the ROM.

For example, the control unit 36 exercises control to cause the encoding/decoding unit 32 to start moving image compression processing on captured image data input from the image signal processing unit 31 in accordance with an operation of the REC button 9r provided as the input unit 35 and to cause the media drive 34 to record the compressed captured image data obtained by the above processing in a recording medium.

When still images are shot, the control unit exercises control to cause the encoding/decoding unit 32 to perform still image compression processing on captured image data input from the image signal processing unit 31 in accordance with a shutter operation (release operation) via the input unit 35 and to cause the media drive 34 to record the compressed captured image data obtained by the above processing in a recording medium.

As the shutter operation, for example, an operation on a shutter button displayed on the display 10 can be adopted. Alternatively, the REC button 9r can also be used as an operation button for the shutter operation.

Further, the control unit 36 also exercises control to cause the display unit 33 (display 10) to display images based on captured image data obtained by the image signal processing unit 31 when one of various shooting modes described above is set as through images.

Further, the control unit 36 exercises driving control of the protruding portion 8. More specifically, the control unit 36 controls the protrusion driving unit 39 such that the protruding portion 8 is driven to a state protruding from the bottom of the first housing 2 in accordance with activation of the imaging apparatus 1 after being turned on and controls the protrusion driving unit 39 such that the protruding portion 8 is driven to a state not protruding from the bottom of the first housing 2 in accordance with power-off of the imaging apparatus 1.

As described above, the imaging apparatus 1 according to the present embodiment is configured such that the power is turned on/off by the second housing 3 being opened/closed. Therefore, with the driving control of the protruding portion 8 being exercised by the control unit 36 as described above, the protruding portion 8 protrudes from the bottom of the first housing 2 in accordance with opening of the second housing 3 and the protruding portion 8 is brought back to a state of not protruding from the bottom of the first housing 2 in accordance with closing of the second housing 3.

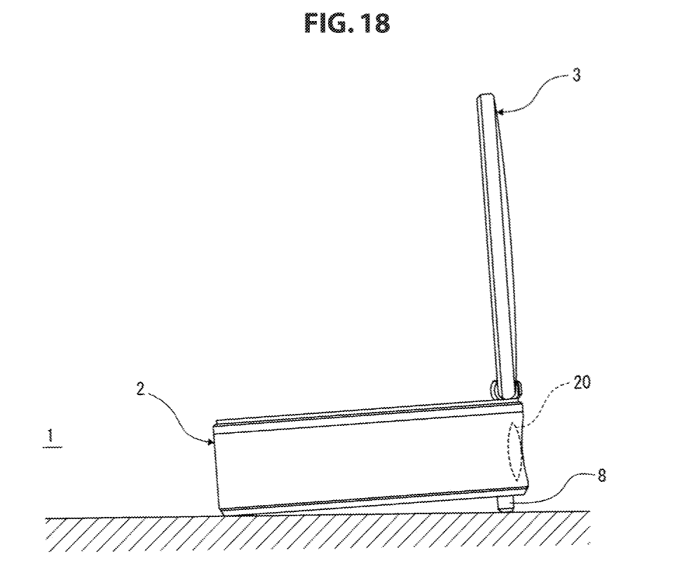

FIG. 18 shows the imaging apparatus 1 in a stationary shooting state placed on a placement object such as a table while the protruding portion 8 is protruded as a left side view.

When the imaging apparatus 1 is used in a stationary state, the protruding portion 8 protruding from the bottom of the first housing 2 as shown in FIG. 18 functions as a stand to adjust the optical axis of the imaging optical system (hereinafter, denoted as the “imaging optical axis”) including the imaging lens 20. Therefore, the imaging apparatus 1 can shoot independently of the angle of the surface on which the imaging apparatus 1 is placed.

As shown in FIG. 6, the protruding portion accommodation port 2h is provided near the end on the side closer to the mounting position of the imaging lens 20 at the bottom of the first housing 2. In other words, the protruding portion 8 protrudes from the neighborhood of an end on the side closer to the mounting position of the imaging lens 20 at the bottom.

Accordingly, the imaging optical axis is adjusted upward from the surface on which the imaging apparatus is placed.

When, for example, the imaging apparatus 1 is placed on a placement object such as a table for self shooting, the face of the cameraman is assumed to be on the upper side from the horizontal direction (direction parallel to the placement surface) and thus, as described above, that the imaging optical axis is adjusted upward from the placement surface is desirable.

The formation position of the protruding portion accommodation port 2h, that is, the position from which the protruding portion 8 protrudes is, if the direction parallel to the imaging optical axis is defined as a depth direction of the imaging apparatus 1, a center portion in a direction orthogonal to the depth direction (left and right directions) at the bottom of the first housing 2. A center line c shown in FIG. 6 represents the center line of the imaging apparatus 1 (first housing 2) in the direction orthogonal to the depth direction and in the present example, the center of the protruding portion accommodation port 2h matches the center line c.

With the position from which the protruding portion 8 protrudes being set to be the center portion in the direction orthogonal to the depth direction at the bottom of the first housing 2, the first housing 2 is prevented from tilting in the direction perpendicular to the depth direction of the first housing 2 accompanying the protrusion of the protruding portion 8.

Thus, angles other than the elevation angle of the optical axis are prevented from changing and therefore, captured images can be prevented from tilting in a left and right directions. The description will return to FIG. 17.

In the present embodiment, in addition to the processing for the control of each unit described above, the control unit 36 performs processing described below in accordance with various shooting modes and shooting states described above.

<4. Processing in Accordance with Shooting Mode/Shooting State>

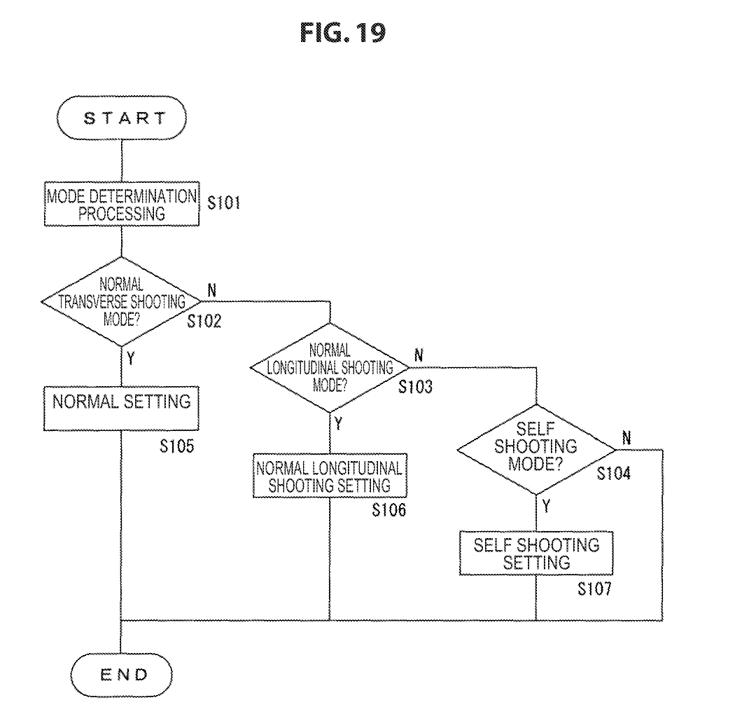

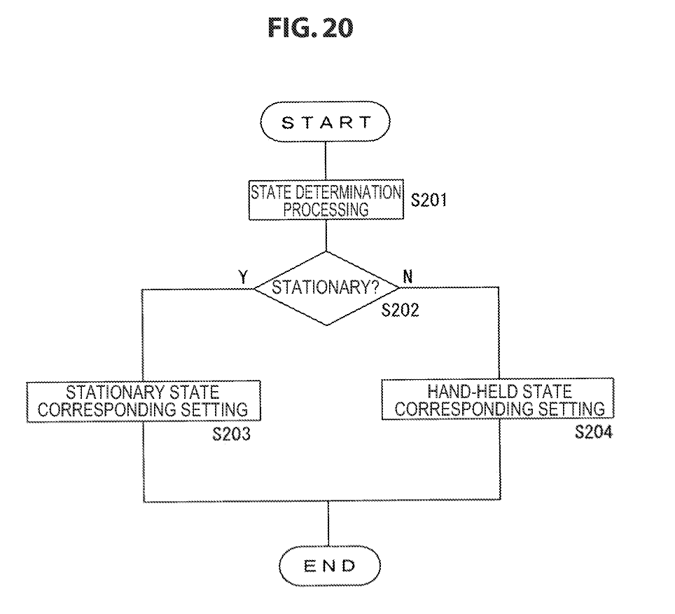

FIGS. 19 and 20 show a flow chart of processing in accordance with the shooting mode and a flow chart of processing in accordance with the shooting state of the imaging apparatus 1.

The processing shown in these diagrams is performed by the control unit 36 according to, for example, a program stored in the aforementioned ROM or the like. In addition, the processing shown in these diagrams is assumed to be processing started, for example, at regular intervals.

In FIG. 19, as mode determination processing in step S101, the control unit 36 determines the shooting mode described with reference to FIGS. 12 to 14. More specifically, based on a detection signal by the rotation angle sensor 37 and a detection signal by the acceleration sensor 38, the shooting mode is determined by determining to which of the normal transverse shooting mode, the normal longitudinal shooting mode, and the self shooting mode the deformed state and posture of the current imaging apparatus 1 correspond.

In step S101, if the rotation angle θ2 of the second housing 3 is in the range of 270 degrees or more and less than 90 degrees centering at 0 degrees and the posture of the imaging apparatus 1 is a posture corresponding to landscape orientation (for example, the acceleration DC component in the z-axis direction is the largest), the control unit 36 obtains a determination result that the imaging apparatus is in the normal transverse shooting mode.

If the rotation angle θ2 of the second housing 3 is in the range of 270 degrees or more and less than 90 degrees centering at 0 degrees and the posture of the imaging apparatus 1 is a posture corresponding to portrait orientation (for example, the acceleration DC component in the x-axis direction or the y-axis direction is the largest), the control unit 36 obtains a determination result that the imaging apparatus is in the normal longitudinal shooting mode.

Further, if the rotation angle θ2 of the second housing 3 is in the range of 90 degrees or more and less than 270 degrees centering at 180 degrees, the control unit 36 obtains a determination result that the imaging apparatus is in the self shooting mode.

Incidentally, conditions of the rotation angle θ1 in each shooting mode described above are satisfied by the control unit 36 being activated.

The control unit 36 determines whether the determination result in step S101 is the normal transverse shooting mode (step S102), the normal longitudinal shooting mode (step S103), or the self shooting mode (step S104).

If the determination result is the normal transverse shooting mode, the control unit 36 performs normal setting processing in step S105 and terminates the processing shown in FIG. 19. If the determination result is the normal longitudinal shooting mode or the self shooting mode, the control unit 36 performs normal longitudinal shooting setting processing in step S106 or self shooting setting processing in step S107 respectively and terminates the processing shown in FIG. 19.

If the determination result is none of the normal transverse shooting mode, the normal longitudinal shooting mode, and the self shooting mode, the control unit 36 terminates the processing shown in FIG. 19.

The control unit 36 exercises control such that at least normal settings predetermined for settings related to imaging of the imaging apparatus 1 are made as the normal setting processing in step S105. In the normal setting processing, for example, a setting is made not to make settings in the self shooting mode. More specifically, restrictions of the focus range as will be later described are not to be imposed, images are not to be rotated and the like.

Also, the control unit 36 exercises control such that, like the normal setting processing described above, a setting is made not to make settings in the self shooting mode and also control is exercised such that images captured/recorded in the normal longitudinal shooting mode are recorded by associating with information indicating longitudinal shooting as the normal longitudinal shooting setting processing in step S106. By recording an image recorded in the normal longitudinal shooting mode by associating with information indicating longitudinal shooting as described above, when the recorded image is played back, the recorded image can be made to be displayed in the correct orientation. More specifically, some recorded images by longitudinal shooting should be displayed on the screen such as the display 10 during playback by rotating playback images by 90 degrees and thanks to the information associated with recorded images as described above, whether to display by rotating by 90 degrees during playback can correctly be determined.

In the normal longitudinal shooting setting processing, instead of associating a recorded image with information indicating longitudinal shooting, an image obtained by rotating a captured image by 90 degrees may be recorded.

The control unit 36 also exercises control such that predetermined settings corresponding to the self shooting mode are made as self shooting settings in step S107. For example, the control unit 36 exercises control such that at least one of settings below is made as a self shooting setting. That is, a setting to cause the display 10 to display a horizontally reversed image of a through image, a setting to limit the focus adjustable range to the close range side (this is because the distance from the imaging lens 20 to the cameraman is limited to about the length of the arm of the cameraman in self shooting), a setting to a face recognition auto-focus, a setting to the centerweighted metering and the like.

The setting to limit the focus adjustable range to the close range side can be made for both of the auto focus and the manual focus. As a self shooting setting, an automatic adjustment of zoom to the angle of view in close range suitable for self shooting can also be considered. Subsequently, FIG. 20 will be described.

In FIG. 20, as state determination processing in step S201, the control unit 36 determines whether the imaging apparatus 1 is in a hand-held shooting state or a stationary shooting state. The determination processing is performed based on the AC component of a detection signal by the acceleration sensor 38. More specifically, for example, whether the amount of amplitude variations of the AC component of detection signals over the last predetermined period in the past is larger than a predetermined threshold. If the amount of amplitude variations is larger than the threshold (more vibration), a determination result of the hand-held shooting state is obtained and if the amount of amplitude variations is equal to or smaller than the threshold (less vibration), a determination result of the stationary shooting state is obtained.

The method of determining the hand-held shooting state/stationary shooting state based on the AC component of acceleration can be considered in various ways and is not limited to the above method.

The determination of the hand-held shooting state/stationary shooting state can also be made by other methods than using the acceleration sensor 38. For example, a method in which a light emitting portion such as LED (light-emitting diode) and a light receiving portion are provided at the bottom of the first housing 2 and the imaging apparatus is determined to be in a stationary shooting state if light emitted by the light emitting portion is detected by the light receiving portion can be cited.

In step S202 that follows, the control unit 36 determines whether the determination result in step S201 is a hand-held shooting state or a stationary shooting state and performs stationary shooting state corresponding setting processing in step S203 if the determination result is the stationary shooting state and terminates the processing shown in FIG. 20. On the other hand, if the determination result is the hand-held shooting state, the control unit 36 performs hand-held shooting state corresponding setting processing in step S204 and terminates the processing shown in FIG. 20.

As the stationary shooting state corresponding setting processing in step S203, the control unit 36 instructs the aforementioned image signal processing unit 31 to weaken the effect of the camera shake compensation processing (camera shake compensation effect) or turn off the camera shake compensation processing. That is, the control unit 36 gives instructions to weaken the camera shake compensation effect compared with a case of the hand-held shooting state or turn off the camera shake compensation processing itself.

By weakening the camera shake compensation effect or turning off the camera shake compensation processing in accordance with the stationary shooting state in which the possibility of camera shaking is extremely low, power consumption can efficiently be reduced.

As the hand-held shooting state corresponding setting processing in step S204, on the other hand, the control unit 36 instructs the image signal processing unit 31 to heighten the camera shake compensation effect compared with a case of the stationary shooting state or turn on the camera shake compensation processing.

A case when the processing shown in FIGS. 19 and 20 is started at regular intervals is illustrated above, but the processing shown in these diagrams can also be started in accordance with a certain level of changes or more of the deformed state or posture of the imaging apparatus 1.

Also, a case when the shooting mode is automatically switched based on the deformed state or posture of the imaging apparatus 1 in all operation modes is illustrated above, but automatic switching of the shooting mode based on the deformed state or posture is not limited to performing for all operation modes and may be performed, for example, for one shooting mode or a portion of shooting modes.

<5. Summary of Embodiment>

As described above, the imaging apparatus 1 according to the present embodiment includes the first housing 2 mounted with the imaging lens 20, the second housing 3 mounted with the display 10, and the connecting portion 4 connecting the first housing 2 and the second housing 3.

The connecting portion 4 includes the first rotation mechanism that makes the second housing 3 openable/closable with respect to the first housing 2 by the second housing 3 being rotated around the opening/closing axis ax1 and the second rotation mechanism that, if the surface of the first housing 2 directly facing the second housing 3 when the second housing 3 is closed by the first rotation mechanism and parallel to the opening/closing axis ax1 is denoted by the first accommodation surface 2s, makes the second housing 3 rotatable around the vertical axis ax2 perpendicular to the first accommodation surface 2s.

Accordingly, when the second housing 3 is rotated by the second rotation mechanism while the second housing 3 is open, the second housing 3 moves like making a circuit on the surface parallel to the first accommodation surface 2s.

Therefore, a portion of the second housing 3 is prevented from covering the first accommodation surface 2s accompanying rotation around the vertical axis ax2 and it becomes unnecessary to take steps such as arranging operation buttons by avoiding a portion on the first accommodation surface 2s that may be covered by the second housing 3 accompanying the rotation and therefore, a lower degree of flexibility in arranging operation buttons can be prevented.

The imaging apparatus 1 also includes the control unit 36 that sets the shooting mode in accordance with a rotation state by the second rotation mechanism of the second housing 3.

Accordingly, the shooting mode appropriate in accordance with the form of using the imaging apparatus 1 is set. Therefore, the usability of the imaging apparatus 1 can be improved.

Further in the imaging apparatus 1, the control unit 36 sets the self shooting mode when the rotation angle position of the second housing 3 by the second rotation mechanism is in a predetermined rotation angle position (in the present example, the rotation angle position in “90 degrees≦θ2<270 degrees”) that makes the imaging lens 20 and the opening/closing axis ax1 positioned differently when viewed from the side opposite to the first accommodation surface 2s and sets the normal shooting mode when the rotation angle position is in a predetermined rotation angle position (in the present example, the rotation angle position in “270 degrees≦θ2<90 degrees”) that makes the imaging lens 20 and the opening/closing axis ax1 positioned at the same location when viewed from the side opposite to the first accommodation surface 2s.

Accordingly, the self shooting mode and the normal shooting mode can appropriately be set in accordance with the form of using the imaging apparatus 1. Therefore, the usability of the imaging apparatus 1 can be improved.

Further in the imaging apparatus 1, the control unit 36 exercises control such that a horizontally reversed image of a captured image obtained via the imaging lens 20 in the self shooting mode is displayed on the display 10.

Accordingly, the display 10 can be caused to function as a mirror in accordance with a case when the self shooting mode is set. Therefore, it becomes easier for the cameraman to be careful about personal appearances such as a haircut so that the usability of the imaging apparatus 1 can be improved.

In addition, in the imaging apparatus 1, the imaging lens 20 is mounted such that the optical axis of the imaging optical system including the imaging lens 20 is oriented in a direction parallel to the first accommodation surface 2s and in accordance with opening of the second housing 3 from the closed state, the protruding portion 8 is protruded from the bottom as a surface on the opposite side of the first accommodation surface 2s of the first housing 2. Accordingly, the angle of the imaging optical axis when the imaging apparatus 1 is used in a stationary state is adjusted.

Therefore, the imaging apparatus 1 can shoot independently of the angle of the surface on which the imaging apparatus 1 is placed.

Also in the imaging apparatus 1, the protruding portion 8 protrudes from the neighborhood of an end on the side closer to the mounting position of the imaging lens 20 at the bottom of the first housing 2. Accordingly, the imaging optical axis is adjusted upward from the surface on which the imaging apparatus 1 is placed.

Because a subject is present frequently on the upper side of the surface on which the imaging apparatus 1 is placed during stationary shooting, such upward adjustments are suitable for stationary shooting.

Further in the imaging apparatus 1, if the direction parallel to the imaging optical axis is defined as a depth direction, the position from which the protruding portion 8 protrudes is a center portion in a direction orthogonal to the depth direction at the bottom of the first housing 2.

Accordingly, the first housing 2 can be prevented from tilting in the orthogonal direction (left and right directions) accompanying the protrusion of the protruding portion 8.

Thus, angles other than the elevation angle of the imaging optical axis are prevented from changing and therefore, captured images can be prevented from tilting in the left and right directions. Further in the imaging apparatus 1, operation buttons are formed on the first accommodation surface 2s.

Accordingly, while holding the first housing 2 like sandwiching between the side of the first accommodation surface 2s and the bottom side, the cameraman can perform an operation by the thumb of the hand holding the first housing. Therefore, an operation by one hand only is enabled so that the operability can be improved.

In addition, in the imaging apparatus 1, the display 10 is mounted, among surfaces included in the second housing 3, on the second accommodation surface 3s as a surface directly facing the first accommodation surface 2s while the second housing 3 is closed. Accordingly, the display 10 does not appear while the second housing 3 is closed. Therefore, the display 10 can be protected.

Also in the imaging apparatus 1, the second housing 3 has a substantially flat shape whose thickness direction is parallel to the thickness direction of the display 10. Accordingly, the thickness of the second housing 3 can be suppressed. Therefore, the imaging apparatus 1 can be made smaller in size and thinner.

Further in the imaging apparatus 1, the outer edge shape and outer edge size of the first housing 2 when the first housing 2 is viewed from the side opposite to the first accommodation surface 2s and the outer edge shape and outer edge size of the second housing 3 when the second housing 3 is viewed from the side opposite to the second accommodation surface 3s are made substantially identical respectively.

Accordingly, a step can be prevented from being generated on the outer surface of the imaging apparatus 1 while the second housing 3 is closed. Therefore, the imaging apparatus 1 in a closed state of the second housing 3 can easily be gripped and the ease with which the imaging apparatus 1 is handled can be improved.

<6. Modification>

In the foregoing, an embodiment according to the present technology has been described, but the present technology should not be limited to concrete examples illustrated above.

For example, the position of the opening/closing axis ax1 may be on the outer side or the inner side of the first accommodation surface 2s when viewed in the top views like FIGS. 11A to 11C depending on the formation position of the connecting member 7 with respect to the second annular member 6, the formation position of the through hole 7a inside the connecting member 7, or the size setting of the second housing 3 with respect to the first housing 2.

In any case, however, the fact that the second housing 3 moves like making a circuit on the surface parallel to the first accommodation surface 2s by being rotated by the second rotation mechanism is the same. That is, in any case, the fact that a portion of the second housing 3 is prevented from covering the first accommodation surface 2s accompanying the rotation around the vertical axis ax2 is the same.

Also, a case when the outside shape of the first housing 2 and the second housing 3 is a substantially cylindrical shape (substantial disk shape) is illustrated above, but the outside shape of the first housing 2 and the second housing 3 may be other shapes such as a substantially rectangular parallelepiped shape, a substantially regular hexahedron shape and the like.

Also, a case when the self shooting mode is set even if the imaging apparatus 1 is in a portrait posture is illustrated above, the self shooting mode may be made a mode that is set only if the imaging apparatus 1 is in a landscape posture.

Further, the shooting mode is determined above by using both of the rotation angles θ1, θ2, but the shooting mode may be determined based on only the rotation angle θ2. Also in this case, power-on and power-off may be determined by using the rotation angle θ1, that is, the rotation angle around the opening/closing axis ax1.

Further, a case when the protruding portion 8 is caused to protrude regardless of the hand-held shooting state and the stationary shooting state is illustrated above, but the protruding portion 8 may be configured to protrude only in the stationary shooting state. Further, the protruding portion 8 may be configured to protrude only if the self shooting mode is set in the stationary state.

The protrusion of the protruding portion 8 is not limited to unconditional protrusion in accordance with opening of the second housing 3 and, for example, a setting to allow or not allow the protrusion of the protruding portion 8 may be enabled by a setting menu or the like so that the protruding portion 8 is protruded in accordance with opening of the second housing 3 only if the setting allows the protrusion.

Further, the amount of protrusion of the protruding portion 8 may be made variable. For example, changing the amount of protrusion based on operation input can be considered. Alternatively, in response to a case when the subject is a person, controlling the amount of protrusion of the protruding portion 8 by the control unit 36 so that the face of the person appears appropriately in a captured image by using face recognition technology can also be considered. Alternatively, the amount of protrusion of the protruding portion 8 may also be changed based on the rotation angle θ1.

For example, in the case of self shooting in the stationary shooting state, adjusting the elevation angle of the imaging apparatus 1 and the angle of the display 10 so as to be optimal for self shooting can be considered. More specifically, adjusting the elevation angle of the imaging apparatus 1 so that the face of the cameraman is imaged appropriately and the angle of the display 10 so that the cameraman can view through images more easily can be considered. In this case, if the cameraman further opens the second housing 2 (the rotation angle θ1 is further increased) in a stationary state, the cameraman is supposed to desire to move the imaging direction of the imaging apparatus 1 still upward (the face position of the cameraman is supposed to have changed upward by, for example, standing up after sitting and the cameraman is supposed to desire to move the imaging direction still upward correspondingly). In this case, therefore, it is effective to increase the amount of protrusion with an increasing value of the rotation angle θ1. In the opposite case, that is, if the value of the rotation angle θ1 decreases, it is effective to decrease the amount of protrusion correspondingly.

A configuration to cause the protruding portion 8 to electrically protrude is illustrated above, but the protruding portion 8 may mechanically be protruded in accordance with opening of the second housing 3 by transmitting power generated by opening the second housing 3 and providing a mechanism driven in a direction in which the protruding portion 8 is protruded based on the power.

Alternatively, the protrusion of the protruding portion 8 may also be configured to take place in accordance with a predetermined operation, instead of opening of the second housing 3. The protruding portion 8 may have, instead of being rod-like, other shapes such as a plate-like shape.

Though not specifically mentioned above, if the portrait shooting is also supported in the self shooting mode, processing corresponding to the portrait shooting such as recording an image shot during portrait shooting by associating with information indicating longitudinal shooting is performed.

An image apparatus capable of shooting moving images and still images is illustrated above, but the embodiments of the present technology can be applied to image apparatuses capable of shooting at least one of moving images and still images.

An imaging apparatus according to one or more of the embodiments of the present technology can also be configured to be able to communicate by cable or wirelessly with an external device such as a smartphone or tablet terminal directly or via a network. In this case, the imaging apparatus can also be configured to transfer captured images to an external device or to receive operations from an external device.

Effects described in this specification are only illustrative and should not be limited and may include other effects.

It should be understood by those skilled in the art that various modifications, combinations, sub-combinations and alterations may occur depending on design requirements and other factors insofar as they are within the scope of the appended claims or the equivalents thereof.

<7. Present Technology>

Additionally, the present technology may also be configured as below.

(1) An imaging apparatus including:

a first housing mounted with an imaging lens;

a second housing mounted with a display; and

a connecting portion that connects the first housing and the second housing,

wherein the connecting portion includes

a first rotation mechanism that makes the second housing openable/closable with respect to the first housing by rotating the second housing around the opening/closing axis, and

a second rotation mechanism that, in a case where the second housing is closed by the first rotation mechanism, when a surface of the first housing directly facing the second housing and parallel to the opening/closing axis is denoted as a first accommodation surface, makes the second housing rotatable around a vertical axis perpendicular to the first accommodation surface.

(2) The imaging apparatus according to (1), further including:

a control unit that sets a shooting mode in accordance with a rotation state of the second housing by the second rotation mechanism.

(3) The imaging apparatus according to (2), wherein

the control unit

sets a self shooting mode when a rotation angle position of the second housing by the second rotation mechanism is a predetermined rotation angle position that makes the imaging lens and the opening/closing axis positioned at different locations when viewed from a side opposite to the first accommodation surface and

sets a normal shooting mode when the rotation angle position is a predetermined rotation angle position that makes the imaging lens and the opening/closing axis positioned at a same location when viewed from the side opposite to the first accommodation surface.

(4) The imaging apparatus according to (3), wherein

the control unit exercises control in a manner that a horizontally reversed image of a captured image obtained via the imaging lens in the self shooting mode is displayed on the display.

(5) The imaging apparatus according to any one of (1) to (4), wherein

the imaging lens is mounted in a manner that an optical axis of an imaging optical system including the imaging lens is oriented in a direction parallel to the first accommodation surface and

in accordance with opening of the second housing from a closed state, a protruding portion is protruded from a bottom as a surface on an opposite side of the first accommodation surface of the first housing.

(6) The imaging apparatus according to (5), wherein

at the bottom, the protruding portion protrudes from a neighborhood of an end on a side closer to a mounting position of the imaging lens.

(7) The imaging apparatus according to (5) or (6), wherein

when the direction parallel to the optical axis is defined as a depth direction, a position from which the protruding portion protrudes is a center portion in the direction orthogonal to the depth direction at the bottom.

(8) The imaging apparatus according to any one of (1) to (7), wherein

an operation button is formed on the first accommodation surface.

(9) The imaging apparatus according to any one of (1) to (8), wherein

the display is mounted, among surfaces included in the second housing, on a second accommodation surface as the surface directly facing the first accommodation surface while the second housing is closed.

(10) The imaging apparatus according to any one of (1) to (9), wherein

the second housing has a substantially flat shape whose thickness direction is parallel to a thickness direction of the display.

(11) The imaging apparatus according to any one of (1) to (10), wherein

an outer edge shape and an outer edge size of the first housing when the first housing is viewed from a side opposite to the first accommodation surface, and an outer edge shape and an outer edge size of the second housing when the second housing is viewed from the side opposite to the second accommodation surface are made substantially identical, respectively.

What is claimed is:

1. An imaging apparatus comprising:
a first housing mounted with an imaging lens;
a second housing mounted with a display; and
a connecting portion that connects the first housing and the second housing,
wherein the connecting portion includes
a first rotation mechanism that makes the second housing openable/closable with respect to the first housing by rotating the second housing around the opening/closing axis, and
a second rotation mechanism that, in a case where the second housing is closed by the first rotation mechanism, when a surface of the first housing directly facing the second housing and parallel to the opening/closing axis is denoted as a first accommodation surface, makes the second housing rotatable around a vertical axis perpendicular to the first accommodation surface.

2. The imaging apparatus according to claim 1, further comprising:
a control unit that sets a shooting mode in accordance with a rotation state of the second housing by the second rotation mechanism.

3. The imaging apparatus according to claim 2, wherein
the control unit
sets a self shooting mode when a rotation angle position of the second housing by the second rotation mechanism is a predetermined rotation angle position that makes the imaging lens and the opening/closing axis positioned at different locations when viewed from a side opposite to the first accommodation surface and
sets a normal shooting mode when the rotation angle position is a predetermined rotation angle position that makes the imaging lens and the opening/closing axis positioned at a same location when viewed from the side opposite to the first accommodation surface.

4. The imaging apparatus according to claim 3, wherein
the control unit
exercises control in a manner that a horizontally reversed image of a captured image obtained via the imaging lens in the self shooting mode is displayed on the display.

5. The imaging apparatus according to claim 1, wherein
the imaging lens is mounted in a manner that an optical axis of an imaging optical system including the imaging lens is oriented in a direction parallel to the first accommodation surface and
in accordance with opening of the second housing from a closed state, a protruding portion is protruded from a bottom as a surface on an opposite side of the first accommodation surface of the first housing.

6. The imaging apparatus according to claim 5, wherein
at the bottom, the protruding portion protrudes from a neighborhood of an end on a side closer to a mounting position of the imaging lens.

7. The imaging apparatus according to claim 5, wherein
when the direction parallel to the optical axis is defined as a depth direction, a position from which the protruding portion protrudes is a center portion in the direction orthogonal to the depth direction at the bottom.

8. The imaging apparatus according to claim 1, wherein
an operation button is formed on the first accommodation surface.

9. The imaging apparatus according to claim 1, wherein
the display is mounted, among surfaces included in the second housing, on a second accommodation surface as the surface directly facing the first accommodation surface while the second housing is closed.

10. The imaging apparatus according to claim 1, wherein
the second housing has a substantially flat shape whose thickness direction is parallel to a thickness direction of the display.

11. The imaging apparatus according to claim 1, wherein
an outer edge shape and an outer edge size of the first housing when the first housing is viewed from a side opposite to the first accommodation surface, and an outer edge shape and an outer edge size of the second housing when the second housing is viewed from the side opposite to the second accommodation surface are made substantially identical, respectively.
